(19) United States
(12) Patent Application Publication
(10) Pub. No.: US 2015/0050107 A1
(43) Pub. Date: Feb. 19, 2015

(54) Lifting Mechanism for Cart or Platform

(71) Applicant: J. Scott Kipp, Newark, DE (US)

(72) Inventor: J. Scott Kipp, Newark, DE (US)

(21) Appl. No.: 14/249,223

(22) Filed: Apr. 9, 2014

Related U.S. Application Data
(60) Provisional application No. 61/810,266, filed on Apr. 10, 2013.

(51) Int. Cl. B60P 1/02; B60P 3/07; B60P 3/06

(52) U.S. Cl. CPC B60P 1/02; B60P 3/06; B60P 3/07
USPC 414/462

(57) ABSTRACT

The present invention relates to goods or cargo carrying a cart or wagon which can be hitched to the rear of a variety of vehicle by means of a height adjuster. The cart or wagon comprises; a height adjuster, floor or tray, and removable or pivoted wheels with hand breaks. The invention also relates to a lifting mechanism for raising and lowering the cart or wagon to easily load or unload goods which can be carried entirely on the receiver hitch bar of a vehicle. The invention also relates to a lifting mechanism for raising and lowering a platform onto which a scooter or motorcycle has been loaded which can be carried entirely on the receiver hitch bar of a vehicle.

### CROSS-REFERENCE TO RELATED APPLICATION

This application claims the benefit of U.S. Provisional Application No. 61/810,266, filed on Apr. 10, 2013, the disclosure of which is hereby incorporated by reference in its entirety.

### FIELD OF THE INVENTION

The present invention relates to goods carrying a cart or wagon that can be hitched to the rear of a variety of vehicle comprising; a height adjuster device, floor or tray and removable wheels. More particularly, the present invention relates to a lifting mechanism to raise and lower the cart or wagon, to easily load or unload goods. And the total assembly can be carried entirely on the receiver hitch bar of any vehicle, and also the cart or wagon can be folded into a compact configuration for storage as per convenience. The present invention also relates to a lifting mechanism to raise and lower a platform upon which a scooter or motorcycle can be easily loaded, transported, and unloaded.

### BACKGROUND OF THE INVENTION

Many people utilize relatively small carts, wagons, enclosed boxes or wheeled platforms to move heavy and/or bulky items from one place to another. Often, it is useful to load a cart with materials, move the loaded cart to an automobile, truck, recreational vehicle, trailer, boat or other vehicle and then unload the materials from the cart into the vehicle for transport to a more distance place, such as a campsite, jobsite or other places. For instance, many people enjoy going camping, hunting or other outdoor activities that typically require a number of different items, which can be conveniently carried to the vehicle by a cart and then transported to the camping, hunting or other outdoor location. It is often convenient, desirable or even necessary to utilize the cart to move or store the materials at the remote location when unloading the materials from the vehicle.

The art of loading and unloading heavy loads or equipment into vehicles generally requires the use of loading equipment and/or considerable labor on the part of a person or persons performing the load/unload operations. Those involving frequent loading and unloading, trailers are inadequate for the task because of bulk and weight of the trailer and difficulties in hitching and unhitching. Moreover, many types of equipment must be moved to a secondary field location after unloading, which requires, in many instances, considerable additional labor.

The need to utilize the cart at the remote location creates many difficulties, namely lifting the cart into the vehicle and fitting the cart inside most vehicles. Even more time and effort is taken to unload the materials from the cart to the vehicle prior to loading the cart in the vehicle. In addition, because the typical cart comprises a cart body having a plurality of wheels attached thereto and a tow handle at one end for pulling the cart, many people have trouble lifting and moving the cart into a vehicle. If a cart is large enough to carry much materials, which is generally more desirable, it will not fit inside most automobiles and will even have trouble fitting into many of the larger sized vehicles, such as trucks and sport utility vehicles. Although many carts could fit inside the bed of a pickup truck, the interior of a recreational vehicle or inside other large vehicles, the cart must then be secured to limit movement of the cart while driving so as to prevent damage to the cart, materials inside the cart and/or the vehicle.

A number of different solutions to the above problem exist. One such solution is to utilize a small trailer or trailer-type apparatus that attaches to the vehicle's trailer hitch to carry materials from one location to another. These types of apparatus, however, are generally too large, heavy and difficult to maneuver for the typical person to utilize as a convenient cart to carry materials from and to a vehicle and other locations (i.e., campsites and jobsites). In addition, many people are not comfortable with pulling a trailer behind a vehicle. Some people utilize cargo carriers or tool boxes that are or can be removably attached to the top of the vehicle or inside the vehicle's bed compartment, such as the bed of a pickup truck. These cargo carriers and tool boxes are generally configured to merely receive the materials at the vehicle and are not suited for carrying materials back and forth to the vehicle in the cargo carrier or tool box.

Hunting carts are known which had many disadvantages. One major disadvantage is that hunting carts are too low to the ground. This results in dragging the cart, hanging up on ground obstructions, and requires excess strength for pulling the cart.

Some cargo carriers are known which have a hitch sleeve on the bottom of the carrier and a trailer hitch shaft which can be inserted into a receiver style trailer hitch on a vehicle. The trailer hitch shaft can also be inserted into the hitch sleeve on the bottom of the carrier. These carriers have no convenient means for lifting or moving the carrier. Other cargo carriers are known which also have legs with wheels where the legs can be raised and lowered by hand. Although these types of cargo carriers can be transported on their wheels, they are difficult to raise and lower by hand if they are heavy. Many have rotatable legs with wheels which can be rotated up off the ground when the cargo carrier is attached to a vehicle, but the legs are not height-adjustable.

In order to overcome some of these limitations, a cart or wagon with removable wheels has been constructed so that a heavy load can be easily raised and lowered and also be moved from one location to another by hitching to a vehicle. However, wheels can be removed from the cart or wagon after it has been hitched to a vehicle. In addition, the Height Adjuster can be removed from the vehicle after reaching the destination place and secured into box provided in vehicles or cars to prevent corrosion or damage.

The preferred cart or wagon hitch mountable carrier should be completely useful, capable of being raised to and lowered from the vehicle's hitch. And also utility with a combination of capabilities, including an ability to be carried entirely on a receiver hitch bar, an ability to be quickly loaded to and unloaded from the receiver hitch bar, and is still capable of being easily moved around a job site. Such system would enable loading, subsequent unloading of relatively heavy load while reducing traditional labor requirements associated with the complicated task.

In another use, many people utilize a platform attached to a vehicle's hitch to move heavy scooters or motorcycles from one place to another. The platform, attached off the ground, requires that the user lift the scooter or motorcycle in order to place it on the platform for transport. This can be difficult for a single person to accomplish.

One solution to solve this problem is to attach a ramp to the end of the platform and roll the scooter or motorcycle up and onto the platform. This, however, is also difficult because the weight of the scooter or motorcycle can cause the user to lose control of the scooter or motorcycle, resulting in the scooter or motorcycle falling from the ramp and potentially injuring the user.

In order to overcome some of these limitations, a Height Adjuster with platform has been constructed so that a scooter or motorcycle can be easily raised and lowered and also be moved from one location to another by hitching to a vehicle. In addition, the Height Adjuster can be removed from the vehicle after reaching the destination place.

### SUMMARY OF THE INVENTION

The present invention relates to goods carrying a cart or wagon can be hitched to the rear of a variety of vehicle comprising; a height adjuster device, floor or tray for loading platform, and removable or pivoted wheels with hand brakes. More particularly, the present invention relates to a lifting mechanism to raise and lower the cart or wagon to easily load or unload goods and can be carried entirely on the receiver hitch bar of a towing vehicle, and also can be folded into a compact configuration for storage as per convenience.

In one embodiment of the present invention relates to goods carrying cart or wagon comprises of floor or tray adapted as a loading area and frame for supporting other features; and a height adjuster to adjust the elevation of the cart or wagon. The cart or wagon comprises wheels with hand brakes which can be removable or pivoted. The floor or tray has a center support member, a first end and a second end, the first end integrally formed as a hitch connector with height adjuster. The base of floor or tray is preferably grated and the top surface provides an area to carry goods.

In one embodiment, the present invention generally relates to a height adjuster pivotally mounted at predetermined positions on the front side of cart or wagon and the rear side of vehicles to raise and lower the cart or wagon to be moved to a desired location.

An advantage of the present invention of goods carrying cart or wagon that can be easily raised or lowered by height adjuster to hitch to a vehicle.

Another advantage of the present invention of goods carrying cart or wagon comprises wheels which allow the carrier to be easily transported from one location to another.

Another advantage of the present invention of goods carrying cart or wagon that is easy to hitch to a variety of vehicle.

The present invention also relates to a lifting mechanism to raise and lower a platform upon which a scooter or motorcycle can be easily loaded, transported, and unloaded.

In one embodiment, the present invention relates to a platform for carrying a scooter or motorcycle; and a height adjuster to adjust the elevation of the platform. The platform is mounted on the height adjuster which can be mounted on the rear side of vehicles to raise and lower the platform carrying the scooter or motorcycle to be moved to a desired location.

An advantage of the present invention of the platform on the height adjuster is that the platform can be easily raised or lowered by the height adjuster to hitch to a vehicle.

Another advantage of the present invention of the platform on the height adjuster is that it is easy to hitch to a variety of vehicles.

### BRIEF DESCRIPTION OF THE DRAWINGS

The present invention will become more clearly appreciated as the disclosure of the present invention is made with reference to the accompanying drawings. In the drawings:

FIG. 1 is a diagrammatic representation of goods carrying cart or wagon of the present invention comprising; a floor or tray with wheels and height adjuster for elevation or height adjustment for hitching to vehicles, in which various embodiment of the present invention may be practiced.

FIG. 2 is a diagrammatic representation of goods carrying cart or wagon of the present invention wherein FIG. 2a shows cart or wagon in ground level before elevation and FIG. 2b Shows cart or wagon elevated by the height adjuster so that the hitch shaft will fit over the vehicle shaft and can be pushed towards the vehicles, in which various embodiment of the present invention may be practiced.

FIG. 3 shows the features of the height adjuster in more detail, in which various embodiment of the present invention may be practiced.

FIG. 4 shows outer shell (FIG. 4a) and inner shell (FIG. 4b) of the height adjuster in diagrammatic representation, in which various embodiment of the present invention may be practiced.

FIG. 5 shows the features in diagrammatic representation of the hitch shaft or hitch sleeve, in which various embodiment of the present invention may be practiced.

FIG. 6 is a perspective view of threaded screw and volts which are placed in center between outer shell (FIG. 4a) and inner shell (FIG. 4b) of the height adjuster for the elevation.

FIG. 7 shows a top view of height adjuster with platform lift.

FIG. 8 is a diagrammatic representation of the height adjuster with the platform lift attached to the platform supports of the inner shell.

FIG. 9 shows the features of the platform of the height adjuster in more detail, in which various embodiment of the present invention may be practiced.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

In order to overcome some of limitations discussed above, cart or wagon have been constructed so that heavy goods can be carried by hitching to variety of vehicle by means of height adjuster support. The cart or wagon can be easily raised and lowered and also be moved from one location to another.

The present invention relates to goods carrying cart or wagon can be hitched to the rear of a variety of vehicle comprising; a height adjuster device, floor or tray, and removable or pivoted wheels with hand brakes. More particularly, the present invention relates to a lifting mechanism to raise and lower the cart or wagon to easily load or unload goods and can be carried entirely on the receiver hitch bar of a vehicle, and also can be folded into a compact configuration for storage as per convenience.

In one embodiment, the present invention relates to goods caring cart or wagon shown in FIG. 1. The cart or wagon of the present invention comprises of a floor or tray (102) adapted as a loading area and frame for supporting other features; and a height adjuster (104) to adjust the elevation of the cart or wagon. The cart or wagon also comprises wheels (106) with hand breaks which can be removable or pivoted. The floor or tray (102) has a center support member (not shown in figure), a first end and a second end, the first end integrally formed as a hitch connector with height adjuster. The base of floor or tray is preferably grated and the top surface provides an area to carry goods.

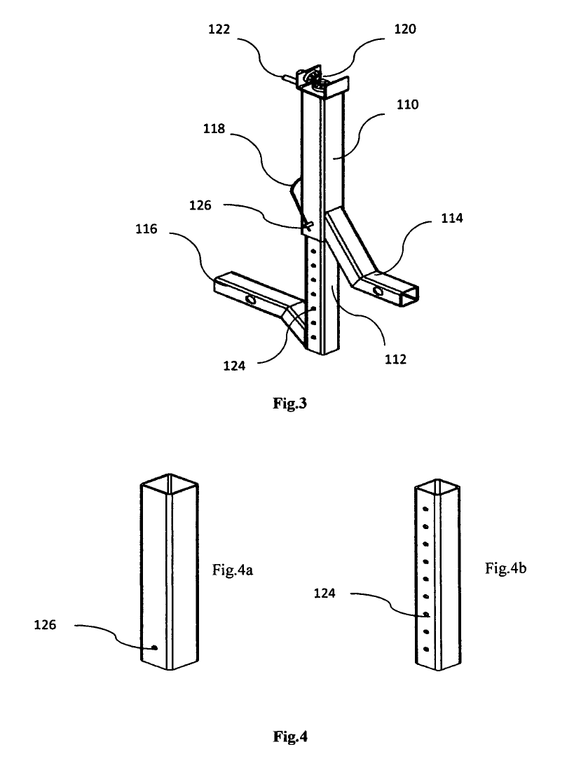

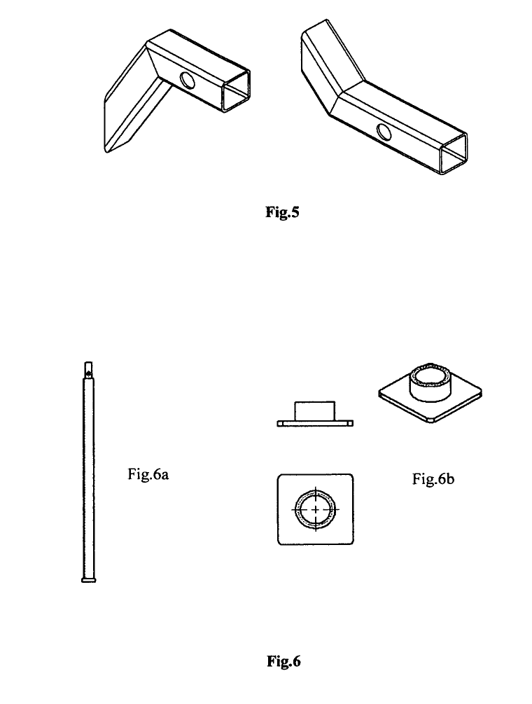

In one embodiment, the present invention provides height adjuster (104) assembly of FIG. 1 and shown in more detail in FIG. 3 comprising two square or cylindrical shells i.e. outer shell (110) and inner shell (112), a handle and a threaded screw (FIG. 6a) inside outer shell (110) and inner shell (112), with volts (FIG. 6b) between outer shell (110) and inner shell (112).

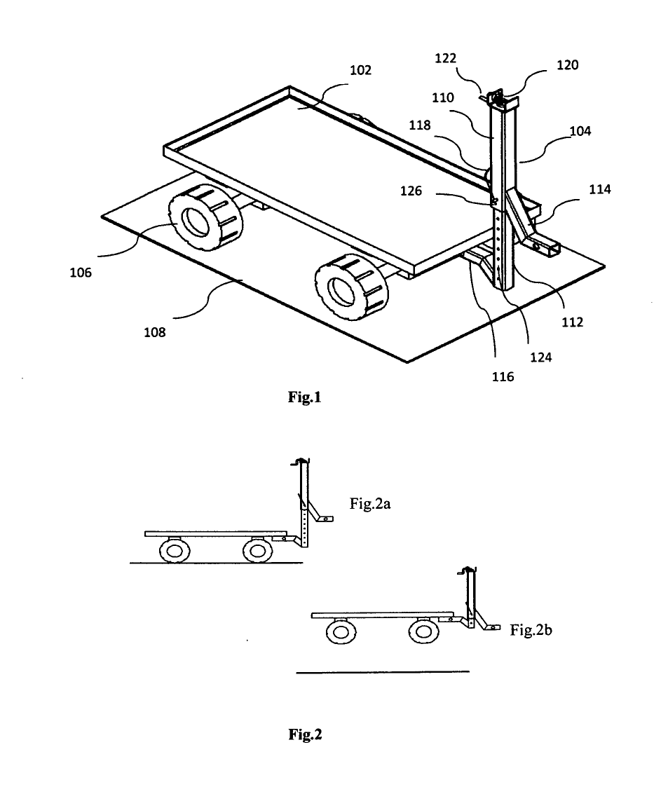

As further shown in FIG. 3, the inner shell (112) comprises multiple holes or slots (124) at different heights and outer shell (110) comprises one hole or slot at lower base (126), as shown in more detail FIG. 4. A locking pin (118) can be inserted between holes or slots of outer shell and inner shell when required elevation above ground level has been obtained and depicted in FIG. 2b.

Height adjuster (104) of FIG. 1 comprises two tubular or square rod shape shaft for hitching, and as shown in FIG. 3, the first shaft connects to vehicle (not shown in figure) with vehicle hitch point (114) and second shaft connects to cart or wagon at cart or wagon hitch point (116) (the shafts are also shown in FIG. 5 for more clarity).

In one embodiment, as shown in FIG. 1 and FIG. 3, the present invention provides a height adjuster with handle (122), when the handle is rotated the outer shell (110) and inner shell (112) moves up and down with each other in anti-parallel manner as needed to raise and lower the elevation of the cart or wagon. The handle (122) movement is guided by bevel gear (120) arrangement.

In one embodiment, as shown in FIG. 1, the present invention relates to a height adjuster (104) which is pivotally mounted at predetermined positions on the front side of cart or wagon (102) at cart or wagon hitch point (116) and the rear side of vehicle (not shown in figure) at vehicle hitch point (114). The height adjuster can be placed in a locked and unlocked position by inserting or removing locking pin (118). FIG. 2a illustrates the cart or wagon in the lowered position. FIG. 2b illustrates the cart or wagon in the raised and locked position.

In one embodiment of the present invention, as shown in FIG. 1, the cart or wagon is mounted on one or more pneumatic swivel castors or wheels (106) allowing for mobility. The pneumatic swivel castors or wheels (106) can be locked in place or also can be removed when not in use.

Preferably the pneumatic swivel castors or wheels (106) are of appropriate diameter and width to ease transportation over soft and irregular ground.

Operation of the cart or wagon is illustrated in FIG. 1 and FIG. 2. The cart or wagon is shown without a load for purposes of clarity.

In FIG. 1, the handle (122) is pumped raising or lifting the cart or wagon (102) to a level in alignment with the vehicle. The handle (122) rotated until the cart or wagon hitch and vehicle's hitch engage. The cart or wagon is then locked to vehicle by conventional means.

The cart or wagon will be manually adjusted to an appropriate height of 10″-20″ for clearance to ground (FIG. 2b).

The cart or wagon of FIG. 1 can be attached to the vehicle and hauled to destination. Upon arrival cart or wagon is manually lowered, unhitched from vehicle and pneumatic swivel castors or wheels (106) can be locked for more control while being pulled.

The height adjuster (104) of FIG. 1 can be removed and cart or wagon can be pulled away from vehicle and also hitch shaft can be removed. The cart or wagon (102) can then be moved on its wheels to any desired location.

Another embodiment, as shown in FIG. 1, of the present invention provides a height adjuster (104) with locking pin mechanism whereby locking pin (118) fit into holes or slots between outer shell (110) and inner shell (112), keeping height adjuster (104) in a locked position during transporting, thereby proving external support to lift goods in cart or wagon (102) above the ground level (108). Holes or slots (124) and (126) are constructed to accommodate locking pin (118) and can be clamped to any desired position. FIG. 4b and FIG. 4a illustrate the holes or slots (124) and (126) and their relative positions in more detail.

In the preferred embodiment of the present invention, as shown in FIG. 1, the cart or wagon solves the aforementioned alignment problem by incorporating wheels (106) that are rotatably or pivotally attached to cart or wagon (102). This ability to easily align cart or wagon (102) with hitch assembly is more effective and useful relative to the prior art assemblies.

The height adjuster (104), illustrated in FIG. 1, provides a means for secure, easy, and precise raising and lowering of the cart or wagon (102), even with loads up to 1000 pounds. The wheels (106) are rotatably attached to the carrier so that they can be rotated off the ground when hitched to a vehicle, allowing the wheels to remain on the cart or wagon (102) while being transported by a vehicle.

It is an object of the present invention to provide a cart or wagon (102) which can be adjusted in elevation through use of height adjuster (104). Movement of the cart or wagon (102) is possible through the use of the wheels (106).

The present invention will allow user to load goods directly on to a cart or wagon (102) and also provides securement of goods via tie downs straps.

In another embodiment of the present invention goods carrying a cart or wagon comprised of a cart platform floor or tray (102) with removable side rails that can accommodate tie down straps.

In another embodiment of the present invention goods carrying cart or wagon provides variable combination of wheels arrangement. For an example cart or wagon (102) will have one pneumatic swivel caster on each corner for mobility which allows cart to maneuver in any direction to receive hitch of connecting vehicle. Another example cart or wagon (102) will have one pneumatic swivel caster on opposite corner of on rear of cart or wagon only, where Front of cart or wagon platform will be maneuvered via solid axle attached to T handle and front wheels affixed to solid axle will be stopped with cable based brake system.

In another embodiment, the present invention goods carrying cart or wagon provide T handle (not shown in figure) to maneuver platform will be lockable to frame for transport on vehicle. Opposite of T handle under cart platform two locking mechanisms will keep rear swivel casters or wheels in place to aid in control while being pulled.

In another embodiment, the present invention goods carrying cart or wagon provides a 2×2″ square tube for supporting that will run length perpendicular to the vehicle. The square tube will be attached to two K style cross members to strengthen and support cart.

In another embodiment, the present invention goods carrying cart or wagon allows user to load cargo or goods directly on to platform and held with removable side rails that can be secured via tie downs. The user will then manually pull the cart using its lock in place T handle. The cart is mounted on pneumatic swivel castors or wheels allowing for mobility. The rear pneumatic swivel castors or wheels can be locked in place by a swing arm attached to platform.

In another embodiment, the present invention goods carrying cart or wagon allows user to attached to the vehicle and hauled to destination. Upon arrival cart or wagon (102) is manually lowered, pin is removed from height adjuster (104) and once cart or wagon (102) is away from vehicle the rear pneumatic swivel castors or wheels (106) can be locked in placed with swing arm for more control while being pulled.

In another embodiment, the present invention goods carrying cart or wagon provide hitched lifting mechanism by using a rack and pinion, hydraulic or screw height adjuster device.

The unique arrangement described above enables a user, with the cart or wagon (102) supported on wheels (106), to lift and, therefore, hitching shaft or sleeve to the height of a receiver hitch bar on a towing vehicle, to facilitate coupling thereto manual lifting that would be associated with height adjuster (104) assembly.

The height adjuster (104) assembly comprising of inner shell (112) comprises multiple holes or slots (124) at different heights and outer shell (126) comprises one hole at lower base shown in FIG. 3. In FIG. 6 shows threaded screw (FIG. 6a) and volts (FIG. 6b) which is placed inside outer shell and inner shell of the height adjuster (104) of FIG. 1. The threaded screw provide support to lift arm and extensions of the height adjuster (104), are manufactured of durable steel bar. The volts provide support to tighten outer shell and inner shell with threaded screw for lifting mechanism.

In another embodiment, the present invention goods carrying cart or wagon incorporate a pin and slot to lock the lifting mechanism in place in the event of failure.

FIG. 1 shows the cart or wagon (102) of the present invention in an unfolded position and ready for use. For example, it can be used for hunting, fishing, camping, yard maintenance, farm use, and various other activities and jobs.

As familiar to those skilled in the art, height adjuster assembly should be configured such that operation mechanism is relatively easy for the user to operate. If desired, an electric or hydraulic actuated system can be utilized.

The components of height adjuster assembly must be sized, configured and of sufficient strength to adequately and safely support the anticipated weight of a fully loaded trolley or trailer and balance so that the user can move cart or wagon on wheels or without wheels.

It is an object of the present invention to provide cart or wagon relatively easy to raise to and lower from the vehicle hitch and properly align the cart or wagon therewith for secure attachment to the vehicle hitch.

It is yet another object of the present invention can be utilized to move and transport camping equipment, wood, sporting equipment and many other objects.

The height adjuster assembly is configured to support the cart or wagon to ground or other surface and allow movement across the surface.

It is also an object of the present invention to provide a cart or wagon that is adaptable to a wide variety of different sizes and configurations and which is relatively easy to raise to, lower from and align with a vehicle's tow hitch receiver.

Another object of the invention is to allow for the goods carried on a cart or wagon to be level during operation, allow for easy break down by one person, to allow for one or two man operation.

It is a further object to provide a pivoted or detachable handle to height adjuster device to facilitate movement.

If desired, the cart or wagon may further include additional parts to form a basket for storage of small tools or accessories.

In the embodiments having a mechanical height adjuster device, the device may have a quick-release mechanism for disengaging the height adjuster for rapid repositioning.

In order to overcome some of these limitations discussed above, a Height Adjuster with platform has been constructed so that a scooter or motorcycle can be easily raised and lowered and also be moved from one location to another by hitching to a vehicle. In addition, the Height Adjuster can be removed from the vehicle after reaching the destination place.

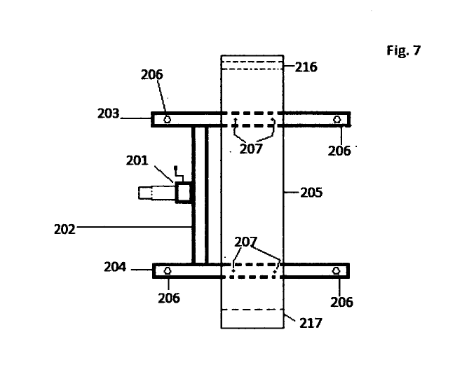

In one embodiment, as shown in FIG. 7, the present invention relates to a height adjuster (201) with offset on outer shell that attaches to vehicle and inner section of assembly that is attached to frame cross member (202). The right platform support (203) and the left platform support (204) are attached to cross member (202). A platform with vertical sides on the long sides of the platform (205) is attached to the tops of the right platform (203) support and the left platform support (204). The height adjuster (201) can be pivoted to an upper position, in a locked position, raising the platform (205) and enabling movement to a desired location. The rear edge (217) of the platform (205) bends downward to allow a user to roll a scooter or motorcycle onto the platform (205). FIG. 9 shows the platform (205) also has a dual bend cup (216) on one end to accommodate the front tire of a scooter or motorcycle to prevent it from rolling forward.

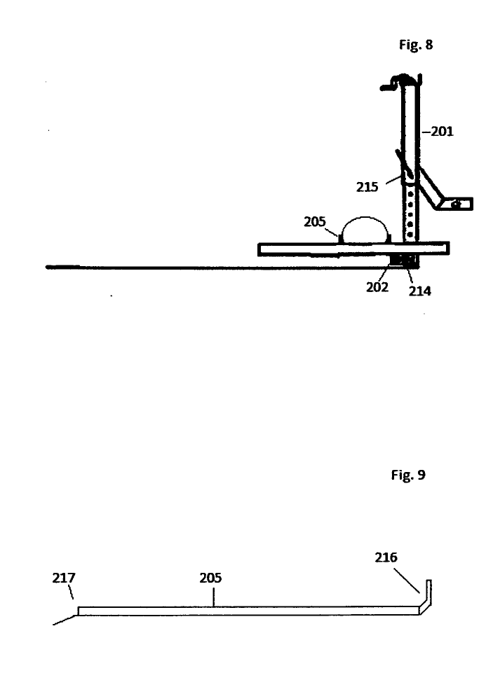

FIG. 8 shows a side view of the height adjuster (201) and platform (205). The bottom of the inner shell (214) is attached to the cross member (202). The outer shell of the height adjuster (201) has one hole near the bottom of the outer shell and the inner shell (214) of the height adjuster (201) has several holes on the side of the inner shell. The inner shell (214) can be lifted and locked in place with a pin (215) through the hole of the outer shell and one of the holes of the inner shell.

FIG. 9 is a side view of the platform (205) showing a bend downward of the rear edge (217) to allow a user to roll a scooter or motorcycle onto the platform.

In a preferred embodiment, as illustrated in FIG. 7, each end of the right platform support (203) and the left platform support (204) will allow for an eye hook (206) to allow tie downs to secure a scooter or motorcycle on the platform (205).

It is further preferred that bolts (207) are used to secure the platform (205) to the right platform support (203) and the left platform support (204).

It is further preferred that the platform (205) is six to eight feet in width, with one to two inch vertical sides, and a six to eight inch dual bend cup (216).

It is an object of the present invention to provide a platform (205) which can be adjusted in elevation through use of height adjuster (201).

The present invention will allow user to load scooters or motorcycles directly on to a platform (205) and also provides securement of the scooter or motorcycle via tie downs straps.

In another embodiment, the present invention provides hitched lifting mechanism by using a rack and pinion, hydraulic or screw height adjuster device.

As familiar to those skilled in the art, height adjuster assembly should be configured such that operation mechanism is relatively easy for the user to operate. If desired, an electric or hydraulic actuated system can be utilized.

The components of height adjuster assembly must be sized, configured and of sufficient strength to adequately and safely support the anticipated weight of a scooter or motorcycle.

It is an object of the present invention to provide a platform at ground level that has been attached to a vehicle hitch that will allow a user to safely load a two wheeled scooter or motorcycle. It is a further object that the scooter or motorcycle is safely secured to the platform via straps that are tied to the eye hooks on the platform supports. Once the scooter or motorcycle is secured to the platform, the user can raise the platform by turning the handle on the height adjuster assembly via internal screw jack mechanism and manually adjusted to an appropriate height of 10″-12″ clearance of platform from the ground and locked in place with a pin through the holes of the outer shell and inner shell.

It is a further object of the present invention that a safely secured scooter or motorcycle can be transported to a destination, whereupon the pin can be removed from the holes of the outer shell and inner shell and the platform manually lowered allowing the scooter or motorcycle to be safely removed.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiments were chosen and described in order to best explain the principles of the invention and its practical application, to thereby enable others skilled in the art to best utilize the invention and various embodiments with various modifications as are suited to the particular use contemplated.

I claim:

1. A height adjuster assembly for attaching to a vehicle and raising and lowering a cart or wagon, the adjuster comprising:
a handle, an outer shell, an inner shell, a threaded screw inside the outer shell and the inner shell, and a locking pin mechanism;
the handle when rotated moving the outer shell and the inner shell up and down in anti-parallel manner;
the outer shell being square or cylindrical in shape, having one hole or slot at its lower end, and having a first tubular or square rod shaped offset shaft connected at its lower end;
the first tubular or square rod shaped angled down from the outer shell and then horizontally;
the inner shell being square or cylindrical in shape, having multiple holes along one side of its length, and having a second tubular or square rod shaped offset shaft connected at its lower end;
the second tubular or square rod shaped shaft angled up from the inner shell and then horizontally;
the handle movement being guided by a bevel gear;
the locking pin allowing the outer shell and the inner shell to be locked into position through the hole in the outer shell and any one of the holes in the inner shell.

2. The height adjuster assembly of claim 1 further comprising a detachable cart, said cart attached to the shaft of the inner shell.

3. The height adjuster assembly of claim 2 further comprising one or more castors or wheels on the detachable cart allowing movement when the cart is detached from the height adjuster assembly.

4. The height adjuster assembly of claim 3 in which the castors or the wheels on the detachable cart are pneumatic swivel castors or wheels.

5. The height adjuster assembly of claim 3 further comprising a hand brake on the cart.

6. A height adjuster assembly for attaching to a vehicle and raising and lowering a platform for transporting a scooter or motorcycle, the adjuster comprising:
a handle, an outer shell, an inner shell, a threaded screw inside the outer shell and the inner shell, and a locking pin mechanism;
the handle when rotated moving the outer shell and the inner shell up and down in anti-parallel manner;
the outer shell being cylindrical or square in shape, having one hole or slot at its lower end, and having a first tubular or square rod-shaped shaft connected at its lower end;
the first square rod-shaped shaft angled down from the outer shell and then horizontally;
the inner shell being square in cross-section, having multiple holes along one side of its length, and having a second tubular or square rod-shaped shaft connected at its lower end;
the second square rod-shaped shaft attached perpendicular to the inner shell;
a cross member being tubular or square in cross-section attached to the inner shell;
a right platform support being tubular or square in cross-section attached to one end of the cross member;
a left platform support being tubular or square in cross-section attached to the opposite end of the cross member;
a platform attached to the tops of the right platform support and the left platform support;
the handle movement being guided by a bevel gear;
the locking pin allowing the outer shell and the inner shell to be locked into position through the hole in the outer shell and any one of the holes in the inner shell.

7. The height adjuster assembly of claim 6 further comprising a vertical lip on each of two long sides of the platform.

8. The height adjuster assembly of claim 7 further comprising a dual bend cup on one end.
